(19) United States
(12) Patent Application Publication
(10) Pub. No.: US 2018/0173186 A1
(43) Pub. Date: Jun. 21, 2018

(54) DATA GENERATING DEVICE AND NON-TRANSITORY COMPUTER-READABLE MEDIUM

(71) Applicant: BROTHER KOGYO KABUSHIKI KAISHA, Nagoya-shi (JP)

(72) Inventors: Satomi YAMAMOTO, Okazaki-shi (JP); Noriharu TASHIRO, Nagoya-shi (JP)

(21) Appl. No.: 15/900,344

(22) Filed: Feb. 20, 2018

Related U.S. Application Data
(63) Continuation of application No. PCT/JP2016/068519, filed on Jun. 22, 2016.

(30) Foreign Application Priority Data
Sep. 30, 2015 (JP) 2015-194297

(51) Int. Cl. G05B 19/18; G06T 11/60; G06K 9/46; G05B 19/4097; B26F 1/38; B26D 5/00; B44C 1/18

(52) U.S. Cl. CPC G05B 19/182; G06T 11/60; G06K 9/4604; G05B 19/4097; G05B 2219/37336; B26D 5/005; B26F 1/3846; B44C 1/18; B26F 1/382

(57) ABSTRACT

A data generating device includes a processor, and a memory. The memory is configured to store computer-readable instructions that, when executed by the processor, instruct the processor to perform processes. The processes include acquiring image data representing a pattern, acquiring graphic data representing a graphic, setting a layout relationship between the pattern and the graphic, and acquiring a reference used in position alignment of the pattern and the graphic. The processes include generating processing data that causes a processing device to perform first processing and second processing. The processing device is configured to carry out a process, including cutting, on a sheet-like workpiece. The first processing is processing to form a plurality of first holes designating the graphic by cutting the workpiece. The second processing is processing to carry out a process at a position on the workpiece corresponding to the reference, on the basis of the layout relationship.

### CROSS-REFERENCE TO RELATED APPLICATION

This application is a continuation application of International Application No. PCT/JP2016/068519, filed Jun. 22, 2016, which claims priority from Japanese Patent Application No. 2015-194297, filed on Sep. 30, 2015. The disclosure of the foregoing application is hereby incorporated by reference in its entirety.

### BACKGROUND

The present disclosure relates to a data generating device and a non-transitory computer-readable medium that generate data used by a processing device capable of carrying out a process, including cutting, on a sheet-like workpiece.

A cutting device is known that can cut a sheet-like workpiece in accordance with cutting data. On the basis of a layout and positions of decorative components, such as rhinestones or the like, the cutting device generates the cutting data for cutting a plurality of holes used for arranging the decorative components on a sheet material, and forms the holes in the sheet material in accordance with the cutting data.

### SUMMARY

When using the sheet material processed using the known cutting device, there is a case in which an operation to perform position alignment, when arranging the decorative components in combination with a pattern (an embroidery pattern, for example), is not easy.

Various embodiments of the broad principles derived herein provide a data generating device and a non-transitory computer-readable medium that generate data capable of simplifying an operation to arrange a plurality of decorative components in combination with a pattern when a sheet-like workpiece is processed using a processing device capable of carrying out a process, including cutting, on the workpiece.

Embodiments provide a data generating device that includes a processor, and a memory. The memory is configured to store computer-readable instructions that, when executed by the processor, instruct the processor to perform processes. The processes include acquiring image data representing a pattern, acquiring graphic data representing a graphic, setting a layout relationship between the pattern and the graphic, and acquiring, on the basis of the pattern represented by the acquired image data, a reference used in position alignment of the pattern and the graphic. The processes include generating, on the basis of the acquired graphic data, processing data that causes a processing device to perform first processing and second processing. The processing device is configured to carry out a process, including cutting, on a sheet-like workpiece. The first processing is processing to form a plurality of first holes designating the graphic by cutting the workpiece. The second processing is processing to carry out a process at a position on the workpiece corresponding to the reference, on the basis of the layout relationship.

Embodiments further provide a non-transitory computer-readable medium that stories computer-readable instructions that, when executed, instruct a processor of a data generating device to perform processes. The processes include acquiring image data representing a pattern, acquiring graphic data representing a graphic, setting a layout relationship between the pattern and the graphic, and acquiring, on the basis of the pattern represented by the acquired image data, a reference used in position alignment of the pattern and the graphic. The processes include generating, on the basis of the acquired graphic data, processing data that causes a processing device to perform first processing and second processing. The processing device is configured to carry out a process, including cutting, on a sheet-like workpiece. The first processing is processing to form a plurality of first holes designating the graphic by cutting the workpiece. The second processing is processing to carry out a process at a position on the workpiece corresponding to the reference, on the basis of the layout relationship.

### BRIEF DESCRIPTION OF THE DRAWINGS

Embodiments will be described below in detail with reference to the accompanying drawings in which:

FIG. 1 is a perspective view of a data generating device;

FIG. 2 is a block diagram showing an electrical configuration of the data generating device;

FIG. 3 is a conceptual diagram of a graphic data storage area and a hole data storage area stored in an EEPROM (Registered Trademark);

FIG. 4 is a flowchart of data generation processing;

FIG. 5 is a flowchart of main processing;

FIG. 6 is an explanatory diagram of a process to set a layout relationship between a pattern and a graphic according to a specific example 1;

FIG. 7 is an explanatory diagram of a process to set a layout relationship between a pattern and the graphic according to a specific example 2;

FIG. 8 is an explanatory diagram of a process to set a layout relationship between a pattern and the graphic according to a specific example 3;

FIG. 9 is an explanatory diagram of a screen;

FIG. 10 is an explanatory diagram of a process to arrange decorative components around a pattern, using processing data generated for the specific example 1;

FIG. 11 is an explanatory diagram of a process to arrange decorative components around a pattern, using the processing data generated for the specific example 2; and

FIG. 12 is a flowchart of main processing according to a modified example.

### DETAILED DESCRIPTION

An embodiment embodying the present disclosure will be explained with reference to the drawings. The drawings referred to are used to explain technical features that can be adopted by the present disclosure, and the configuration of devices etc. illustrated therein are not intended to limit the present disclosure thereto, and are simply explanatory examples.

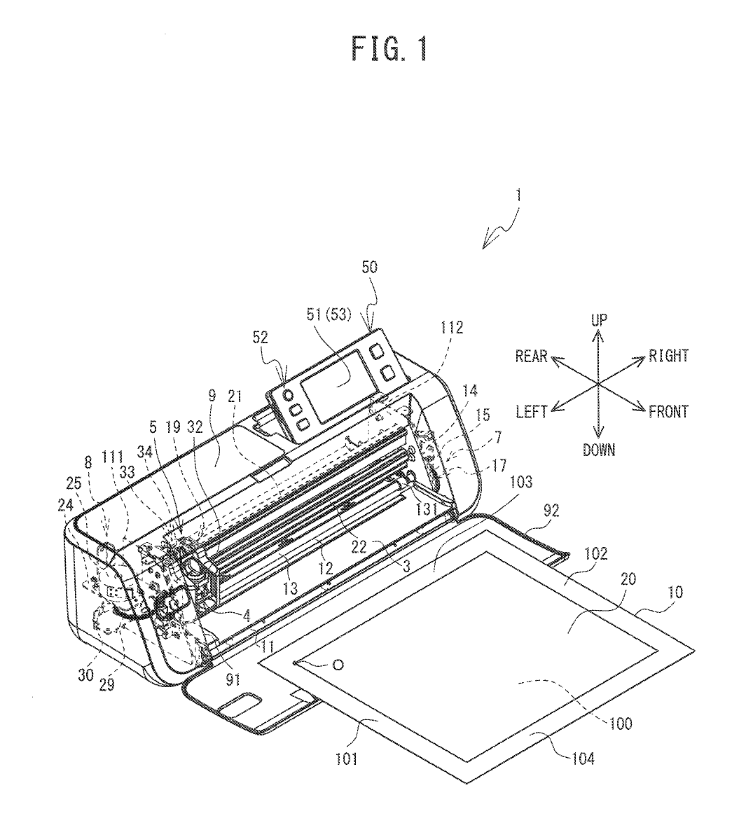

A physical configuration of a data generating device 1 according to the present embodiment will be described with reference to FIG. 1. In the explanation below, the bottom left side, the top right side, the bottom right side, the top left side, the top side, and the bottom side of FIG. 1 respectively denote a left side, a right side, a front side, a rear side, a top side, and a bottom side of the data generating device 1. Specifically, an extending direction of a main body cover 9 to be described later is the left-right direction. A surface on which an operation portion 50 is arranged is a top surface of the data generating device 1.

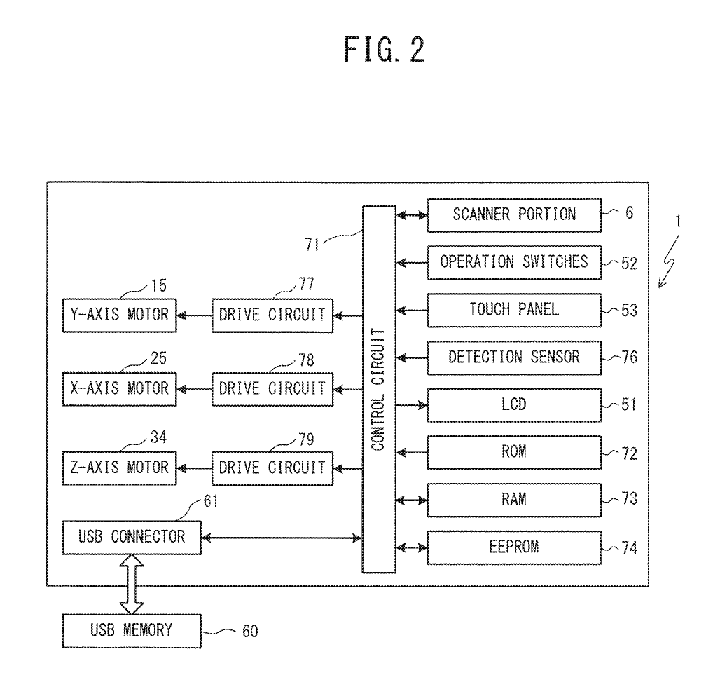

As shown in FIG. 1, the data generating device 1 is a cutting device that is configured to carry out a process, including cutting, on a sheet-like workpiece 20. The workpiece 20 is, for example, a processing cloth, or paper. In addition to processing to cut the workpiece 20, the data generating device 1 of a present example is also configured to draw on the workpiece 20. Further, the data generating device 1 of the present example can generate image data representing an image on a top surface of a target object. The data generating device 1 is provided with the main body cover 9, a platen 3, a head 5, a scanner portion 6 (refer to FIG. 2), a movement mechanism 7, and a head movement mechanism 8.

The main body cover 9 is a substantially cuboid housing that is long in the left-right direction. The main body cover 9 is provided with an opening 91, a cover 92, and the operation portion 50. The opening 91 is an opening provided in a front surface portion of the main body cover 9. The cover 92 is a plate-shaped member that is long in the left-right direction, and is supported on a bottom end side such that it can open and close the opening 91. In FIG. 1, the cover 92 is open, and the opening 91 is thus open.

The operation portion 50 is provided on a portion on the right side of the top surface of the main body cover 9. The operation portion 50 is provided with a liquid crystal display (LCD) 51, a plurality of operation switches 52, and a touch panel 53. The LCD 51 is configured to display an image including various items, such as commands, illustrations, setting values, messages, and the like. The touch panel 53 is provided on the surface of the LCD 51. A user performs a depression operation on the touch panel 53 using a finger or a stylus pen (hereinafter, this operation is referred to as a “panel operation”). In response to a depression position detected by the touch panel 53, the data generating device 1 recognizes which item has been selected. The user uses the operation switches 52 and the touch panel 53 to select a pattern displayed on the LCD 51, to set various parameters, to perform an input operation and the like.

The platen 3 is provided inside the main body cover 9. The platen 3 is a plate-shaped member that extends in the left-right direction. The platen 3 supports a bottom surface of a retaining sheet 10. The retaining sheet 10 is set on the platen 3 in a state in which the opening 91 is open. The retaining sheet 10 is a rectangular sheet shape. The retaining sheet 10 is formed of a synthetic resin material, for example. An adhesive layer 100 is provided on the top surface of the retaining sheet 10. The adhesive layer 100 is formed by applying an adhesive over a substantially rectangular area on the inside of the retaining sheet 10 excluding peripheral edge portions (a left edge portion 101, a right edge portion 102, a rear edge portion 103, and a front edge portion 104) of the retaining sheet 10. The workpiece 20 is held by being adhered to the adhesive layer 100.

The head 5 is provided with a carriage 19, a cartridge holder 32, and an up-down drive mechanism 33. The cartridge holder 32 and the up-down drive mechanism 33 are respectively provided to the front and rear of the carriage 19. A cartridge 4 can be detachably mounted in the cartridge holder 32. A plurality of types of the cartridge 4 are prepared, and types of processing members used in processing the respective workpieces 20 differ. The plurality of types of the processing member of the present example are a cutter and a pen. The user can select the cartridge 4 suitable for the type and the thickness of the workpiece 20, and a type of the processing, and can mount the selected cartridge 4 in the cartridge holder 32. The up-down drive mechanism 33 drives the cartridge holder 32 and the cartridge 4 in the up-down direction (also referred to as a Z direction). The up-down drive mechanism 33 is provided with a transmission mechanism (not shown in the drawings) and a Z-axis motor 34 (refer to FIG. 2). The transmission mechanism decelerates the rotational movement of the Z-axis motor 34 and also converts the rotational movement to an up-down movement, and transmits the up-down movement to the cartridge holder 32. The cartridge 4 mounted in the cartridge holder 32 moves between a lowered position and a raised position, in accordance with the driving of the Z-axis motor 34. The lowered position is a position of the cartridge 4 when processing is performed on the workpiece 20. The raised position is a position at which the processing member is separated from the workpiece 20 by a predetermined distance.

The scanner portion 6 is configured so as to be able to read an image on a target object held by the retaining sheet 10 and generate image data, in accordance with commands of a control circuit 71 that will be described later. In the following explanation, an object that is held by the retaining sheet 10 and is a target of the reading by the scanner portion 6 is distinguished from the workpiece 20 and is referred to as the target object. In the present embodiment, the target object is not processed by the data generating device 1, but the target object may be processed by the data generating device 1. The scanner portion 6 is a contact image scanner (CIS), for example. Although not shown in the drawings, the scanner portion 6 is provided with a line sensor, a light source (a lamp) and a lens. The line sensor is provided on a bottom surface of the scanner portion 6, and is provided with a plurality of imaging elements aligned in the left-right direction (also referred to as an X direction) of the data generating device 1. The scanner portion 6 is positioned to the rear of a guide rail 22 that will be described later. The scanner portion 6 extends in the X direction and is provided so as to be oriented downward. A width dimension of the retaining sheet 10 in the X direction is substantially the same as a length in the X direction of the scanner portion 6 (of the line sensor). The scanner portion 6 reads the image on a top surface of the target object when the top surface of the target object held by the retaining sheet 10 is in close proximity to the line sensor.

The movement mechanism 7 is configured to be able to move the retaining sheet 10 set on top of the platen 3 in the front-rear direction (also referred to as a Y direction) of the data generating device 1. The movement mechanism 7 is provided with a drive roller 12, a pinch roller 13, an attachment frame 14, a Y-axis motor 15, and a deceleration mechanism 17. The drive roller 12 and the pinch roller 13 are rotatably supported between a pair of side wall portions 111 and 112 of a machine casing 11 inside the main body cover 9. The drive roller 12 and the pinch roller 13 extend in the X direction and are arranged side by side in the up-down direction. A roller portion (not shown in the drawings) is provided further to the left than a center of the pinch roller 13 in the left-right direction, and a roller portion 131 is provided further to the right than the center in the left-right direction. The attachment frame 14 is fixed to an outer surface side (the right side) of the side wall portion 112. The Y-axis motor 15 is attached to the attachment frame 14. The Y-axis motor 15 is a stepping motor, for example. An output shaft of the Y-axis motor 15 is fixed to a drive gear (not shown in the drawings) of the deceleration mechanism 17. The drive gear meshes with a driven gear (not shown in the drawings). The driven gear is fixed to the right end of the drive roller 12.

When the retaining sheet 10 is conveyed, the left edge portion 101 of the retaining sheet 10 is clamped between the drive roller 12 and the roller portion (not shown in the drawings) provided on the left side of the pinch roller 13. The right edge portion 102 of the retaining sheet 10 is clamped between the drive roller 12 and the roller portion 131. When the Y-axis motor 15 is driven to rotate forward or driven to rotate in reverse, the rotational movement of the Y-axis motor 15 is transmitted to the drive roller 12 via the deceleration mechanism 17. In this way, the retaining sheet 10 is conveyed toward the rear or toward the front.

The head movement mechanism 8 is configured to be able to move the head 5 in a direction intersecting the conveyance direction of the retaining sheet 10, namely, in the X direction. Specifically, the movement direction of the head 5 is orthogonal to the conveyance direction of the retaining sheet 10. The head movement mechanism 8 is provided with a pair of upper and lower guide rails 21 and 22, an attachment frame 24, an X-axis motor 25, a drive gear (not shown in the drawings) that functions as a deceleration mechanism, a driven gear 29, a transmission mechanism 30, and the like. The guide rails 21 and 22 are fixed between the side wall portions 111 and 112. The guide rails 21 and g 22 are positioned above and slightly to the rear of the pinch roller 13. The guide rails 21 and 22 extend substantially in parallel to the pinch roller 13, namely, in the X direction. The carriage 19 of the head 5 is supported by the guide rails 21 and 22 such that the carriage 19 can move in the X direction along the guide rails 21 and 22.

The attachment frame 24 is fixed to the rear portion of an outer surface side (the left side) of the side wall portion 111. The X-axis motor 25 is provided to the rear of the attachment frame 24 and is attached so as to be oriented downward. The drive gear is fixed to an output shaft of the X-axis motor 25. The X-axis motor 25 is a stepping motor, for example. The driven gear 29 meshes with the drive gear. Although not shown in the drawings, the transmission mechanism 30 has a pair of left and right timing pulleys, and an endless timing belt that is stretched over the pair of left and right timing pulleys. One of the timing pulleys is provided on the attachment frame 24 so as to be able to rotate integrally with the driven gear 29. The other of the timing pulleys is provided on the attachment frame 14. The timing belt extends in the X direction and is coupled to the carriage 19. The head movement mechanism 8 converts the rotational movement of the X-axis motor 25 into a movement in the X direction, and transmits the movement in the X direction to the carriage 19. When the X-axis motor 25 is driven to rotate forward or driven to rotate in reverse, the rotational movement of the X-axis motor 25 is transmitted to the timing belt via the drive gear, the driven gear 29, and the timing pulleys. In this way, the carriage 19 is moved in the left direction or the right direction. Then, the head 5 moves in the X direction.

An electrical configuration of the data generating device 1 will be explained with reference to FIG. 2. As shown in FIG. 2, the data generating device 1 is provided with the control circuit 71, and with a ROM 872, a RAM 73, and an EEPROM (Registered Trademark) 74 that are connected to the control circuit 71. The control circuit 71 performs overall control of the data generating device 1, and is mainly configured by a computer (a CPU).

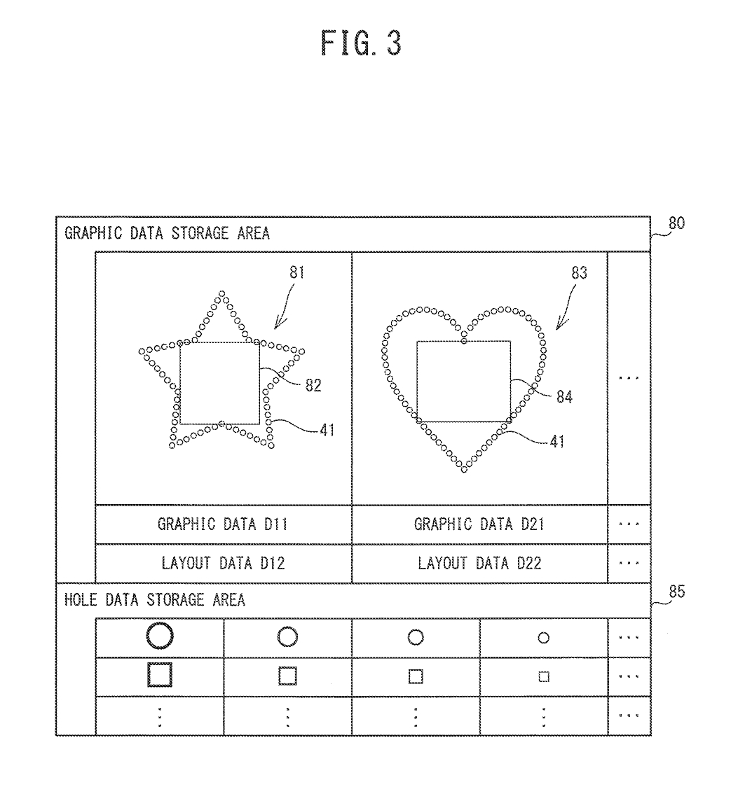

The ROM 72 stores various programs used to operate the data generating device 1, and processing data and the like used to carry out various processes on the workpiece 20. The processing data is data that specifies a processing position on the workpiece 20 using an XY coordinate system (hereinafter referred to as a processing coordinate system) having an origin point O (refer to FIG. 1). The processing data of the data generating device 1 of the present example includes cutting data and drawing data. The cutting data is data specifying a position at which the workpiece 20 is to be cut using the cutter mounted on the cartridge 4. The drawing data is data specifying a position at which a drawing is made on the workpiece 20 using the pen mounted on the cartridge 4. The stored programs are, for example, programs used to cause the data generating device 1 to execute data generation processing and main processing to be described later. The processing data may be stored in an external memory, such as a USB memory 60 or the like. The RAM 73 temporarily stores various programs, various data, setting values input by operation of the operation switches 52 or the like, and calculation results obtained by calculation processing carried out by the control circuit 71. The EEPROM 74 is a non-volatile storage element storing various parameters and the like. The EEPROM 74 is provided with at least a graphic data storage area 80 and a hole data storage area 85 to be described later with reference to FIG. 3.

In addition, the scanner portion 6, the operation switches 52, the touch panel 53, a detection sensor 76, the LCD 51, and a USB connector 61 are connected to the control circuit 71. The control circuit 71 acquires image data by controlling the scanner portion 6 and causing the scanner portion 6 to perform the above-described reading operation. The detection sensor 76 detects a leading edge of the retaining sheet 10 set on the platen 3. A detection signal of the detection sensor 76 is input to the control circuit 71. The control circuit 71 controls the LCD 51 and causes the image to be displayed. The USB connector 61 can be connected to the USB memory 60. Although not shown in detail in the drawings, the USB connector 61 is provided on the right side surface of the main body cover 9. When the USB memory 60 is connected to the USB connector 61, the control circuit 71 can access various storage areas provided in the USB memory 60.

In addition, drive circuits 77 to 79 are connected to the control circuit 71. The drive circuits 77 to 79 respectively drive the Y-axis motor 15, the X-axis motor 25, and the Z-axis motor 34. On the basis of the processing data, the control circuit 71 controls the Y-axis motor 15, the X-axis motor 25, the Z-axis motor 34, and the like, and causes the processing to be automatically performed on the workpiece 20 on the retaining sheet 10.

When the data generating device 1 is used to perform cutting processing, the cartridge 4 having the cutter is mounted in the cartridge holder 32. When the control circuit 71 drives the up-down drive mechanism 33 and causes the cartridge 4 to move to the lowered position, the cutter mounted on the cartridge 4 pierces the workpiece 20 on the retaining sheet 10. In this case, the cutter passes through the workpiece 20, and slightly pierces the retaining sheet 10. In this state, when the control circuit 71 drives the movement mechanism 7 and the head movement mechanism 8 in accordance with the processing data, and the retaining sheet 10 and the cartridge 4 are moved relative to each other in the Y direction and the X direction, the workpiece 20 is cut in a shape specified by the processing data. In other words, when the cutting processing is performed using the data generating device 1, the up-down drive mechanism 33, the movement mechanism 7, and the head movement mechanism 8 function as a cutting mechanism to cut the workpiece 20 in accordance with the processing data.

When drawing processing is performed using the data generating device 1, the cartridge 4 having the pen is mounted in the cartridge holder 32. When the control circuit 71 drives the up-down drive mechanism 33 and causes the cartridge 4 to move to the lowered position, the pen comes into contact with the workpiece 20 on the retaining sheet 10. In this state, when the control circuit 71 drives the movement mechanism 7 and the head movement mechanism 8 in accordance with the processing data, and the retaining sheet 10 and the cartridge 4 are moved relative to each other in the Y direction and the X direction, a pattern of a shape specified by the processing data is drawn on the workpiece 20. In other words, when the drawing processing is performed using the data generating device 1, the up-down drive mechanism 33, the movement mechanism 7, and the head movement mechanism 8 function as a drawing mechanism to draw on the workpiece 20 in accordance with the processing data.

When scanning processing is performed using the data generating device 1, the control circuit 71 drives the movement mechanism 7 and the scanner portion 6 in a state in which the cartridge 4 is maintained in the raised position. While the retaining sheet 10 and the scanner portion 6 move relative to each other in the Y direction, the top surface of the target object held by the retaining sheet 10 is read, and the image data representing the image on the top surface of the target object is generated.

The graphic data will be explained with reference to FIG. 3. The graphic data storage area 80 of the EEPROM 74 stores a plurality of pieces of the graphic data used in processing to set a layout relationship between a pattern and a graphic designated by decorative components. The graphic data of the present example is data representing a graphic of a predetermined shape, using a plurality of hole shapes. The predetermined shape includes various types of shape expressed using a plurality of hole shapes 41, such as a star-shaped graphic 81, and a heart-shaped graphic 83 illustrated in FIG. 3. The graphic 81 is a graphic represented by graphic data D11. The graphic 83 is a graphic represented by graphic data D21. The hole shape is a graphic indicating a size and a shape represented by hole data to be described later. The size and the shape of the hole shape are set so as to correspond to a size and a shape of the decorative component. The size and the shape of the hole shape represent a size and a shape of each of first holes formed in the workpiece 20. The plurality of hole shapes 41 may be one type of the hole shape, or may be a plurality of types of the hole shape where at least one of the size and the shape are different. The hole shapes 41 of the present example are one type of the hole shape, and are a circular shape having a diameter L1.

Layout data is associated with the graphic data of the present example. The layout data represents a shape of a reference rectangle that is used as a reference when setting a layout of the graphic designated by the decorative components with respect to the pattern, and also a layout of the reference rectangle with respect to the graphic represented by the graphic data. A reference rectangle 82 represented by layout data D12 is inscribed inside the graphic 81 and is associated with the graphic 81. The reference rectangle 82 is a rectangular shape. A reference rectangle 84 represented by layout data D22 is inscribed inside the graphic 83 and is associated with the graphic 83. The reference rectangle 84 is a rectangular shape. A layout relationship between the graphic and the reference rectangle may be established in advance, and is not limited to the case in which the reference rectangle is inscribed inside the graphic.

The hole data will be explained with reference to FIG. 3. A plurality of pieces of the hole data are stored in the hole data storage area 85 of the EEPROM 74. With the data generating device 1 of the present example, the shape and size of holes used when setting the layout of the graphic designated by the decorative components with respect to the pattern can be set and can be changed. The hole data represents the shape and size of the holes formed in the workpiece. With respect to each of the shape and the size of the holes represented by the hole data, a plurality of types are prepared while taking into account an application of the processing data and the size and the like of the decorative components. The hole data stored in the hole data storage area 85 may be data that is stored in advance, may be the hole data generated on the basis of shapes and sizes set by the user, or may be data that is temporarily stored. The hole data stored in the hole data storage area 85 may be data obtained from another device.

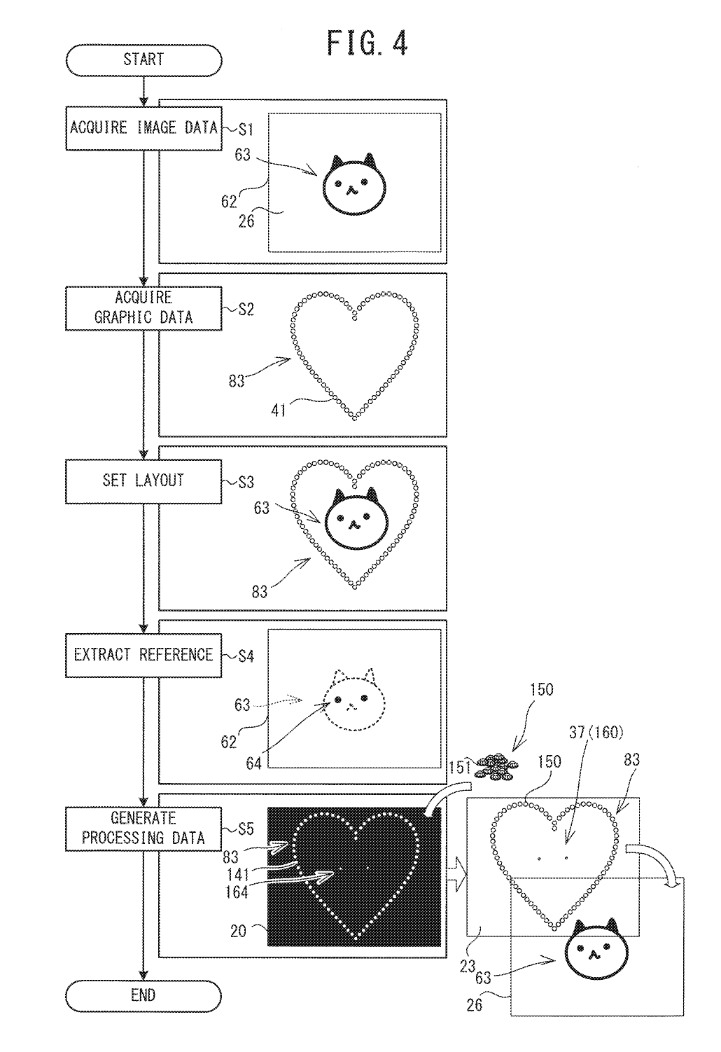

Data generation processing that can be performed by the data generating device 1 will be explained with reference to FIG. 4. The data generation processing is processing that generates data capable of simplifying an operation to arrange the plurality of decorative components in combination with the pattern, when the workpiece 20 is processed using a processing device capable of carrying out a process, including the cutting, on the sheet-like workpiece 20. The processing device of the present example is the data generating device 1. In the data generation processing, processing data is generated as the data capable of simplifying the operation to arrange the plurality of decorative components in combination with the pattern. When the control circuit 71 receives a start command, the control circuit 71 performs the data generation processing shown in FIG. 4, on the basis of the programs stored in the ROM 72. In the present embodiment, the control circuit 71 determines that the data generation processing start command has been received when the start command is input by the panel operation. The start command may be input by another method. For example, the control circuit 71 may determine that the start command has been received when a predetermined switch among the plurality of operation switches 52 is pressed. The start command includes information specifying the graphic selected by the user. As an example, a case will be explained in which the control circuit 71 sets a layout relationship between a pattern 63 and the graphic 83 shown in FIG. 4, and generates the processing data.

When the start command is acquired, the control circuit 71 acquires image data representing a pattern (step S1). The control circuit 71 controls the scanner portion 6 so as to read the top surface of a target object 26 held by the retaining sheet 10 and generate the image data. The control circuit 71 acquires the image data generated by the scanner portion 6. The pattern 63 is included in an image 62 represented by the image data. The control circuit 71 acquires graphic data representing a graphic (step S2). On the basis of information specifying the graphic 83 included in the start command, the control circuit 71 acquires the graphic data D21 from the graphic data storage area 80 of the EEPROM 74. The control circuit 71 sets the layout relationship between the pattern 63 and the graphic 83 (step S3). The control circuit 71 may set the layout relationship between the pattern 63 and the graphic 83 in accordance with a predetermined method, or may set the layout relationship between the pattern 63 and the graphic 83 in accordance with a user command input by the panel operation or the like. In a specific example, the control circuit 71 sets the layout relationship by aligning a center of the pattern 63 with a center of the graphic 83, for example.

On the basis of the pattern 63 represented by the image data acquired at step S1, the control circuit 71 acquires a reference 64 that is used to align the positions of the pattern 63 and the graphic 83 (step S4). It is sufficient that the reference be able to align the positions of the pattern and the graphic. The reference is at least one of a characteristic point (such as a point, an end point, an intersection point, a curve point or the like), or a characteristic graphic (such as a contour line, a minimum rectangle of the pattern or the like). When the reference is the characteristic graphic, the whole of the characteristic graphic may be used as the reference, or a part of the characteristic graphic (a part of the contour line, for example) may be used as the reference. In the specific example, the reference 64 is a point extracted by performing known image processing on the image data.

The control circuit 71 generates the processing data that causes the data generating device 1 to perform each of first processing and second processing (step S5). The first processing is processing to form a plurality of first holes 141 representing the graphic 83 by cutting the workpiece 20, on the basis of the graphic data acquired at step S2. The processing data that causes the first processing to be performed may be the graphic data acquired at step S2. In other words, the graphic data may be cutting data that causes the data generating device 1 to perform processing to form the plurality of first holes 141 representing the graphic 83. In another example, the processing data that causes the first processing to be performed may be cutting data generated using the graphic data. The first holes 141 formed by the first processing may be through holes that penetrate the workpiece 20, or may be non-through recessed portions. The second processing is processing in which, on the basis of the layout relationship set at step S3, a process 164 (such as cutting, drawing, sewing or the like) is carried out at a position on the workpiece 20 corresponding to the reference 64. The control circuit 71 then ends the data generation processing.

A process will be briefly explained in a case in which the user uses the processed workpiece 20 and forms a decorated pattern by combining decorative components 150 and the pattern 63. The decorative component 150 is, for example, a cone-shaped rhinestone that has a diameter slightly smaller than the first hole 141. A thermoplastic adhesive is applied to a bottom surface 151 of the decorative component 150. The processed workpiece 20 is placed on a substantially horizontal table or the like. The plurality of decorative components 150 are arranged on the workpiece 20 in which the plurality of first holes 141 have been formed, and are fitted into the first holes 141 by being swept using a brush or the like, and are held in the first holes 141. When the brush is swept over the workpiece 20, only the decorative components 150 that are arranged with the bottom surface 151 oriented downward are held in the first holes 141, and the decorative components 150 arranged with a different orientation are pushed out from the first holes 141.

When the decorative components 150 are arranged in all of the first holes 141, a transparent or semi-transparent transfer sheet 23 is arranged on the workpiece 20 in a state in which the mutual positions of the decorative components 150 are determined. An adhesive is applied to the bottom surface of the transfer sheet 23. The decorative components 150 adhere to the bottom surface of the transfer sheet 23. Using a writing tool such as a pen, the user makes a mark 37 at the position, corresponding to the reference 64, of the process 164 that has been carried out on the workpiece 20. When the transfer sheet 23 is peeled away from the workpiece 20, the transfer sheet 23 is separated from the workpiece 20 in a state in which the decorative components 150 are adhered to the bottom surface of the transfer sheet 23. The transfer sheet 23 is placed on the target object 26. At this time, the user uses the mark 37 indicating the position of the reference 64 to align the positions of the pattern 63 and the decorative components 150. In the state in which the positions of the pattern 63 and the decorative components 150 have been aligned in the layout relationship set at step S3, heat treatment using an iron or the like is performed on the target object 26 on which the transfer sheet 23 has been placed. The bottom surfaces 151 of the decorative components 150 are fixed to the surface of the target object 26 by the adhesive. The transfer sheet 23 is removed from the target object 26. In this way, the target object 26 is obtained on which the pattern 63 and the decorative components 150 are combined.

When the process 164 carried out, on the basis of the layout relationship set at step S3, on the position on the workpiece 20 corresponding to the reference 64 includes the formation of holes (second holes), decorative components 160, on the bottom surface of which the adhesive is not applied, may be arranged in the formed holes, as well as the decorative components 150 being arranged in the first holes 141. Then, the decorative components 150 and the decorative components 160 may be adhered to the bottom surface of the transfer sheet 23, and in this state, the positions of the pattern 63 and the decorative components 150 may be aligned using the decorative components 160.

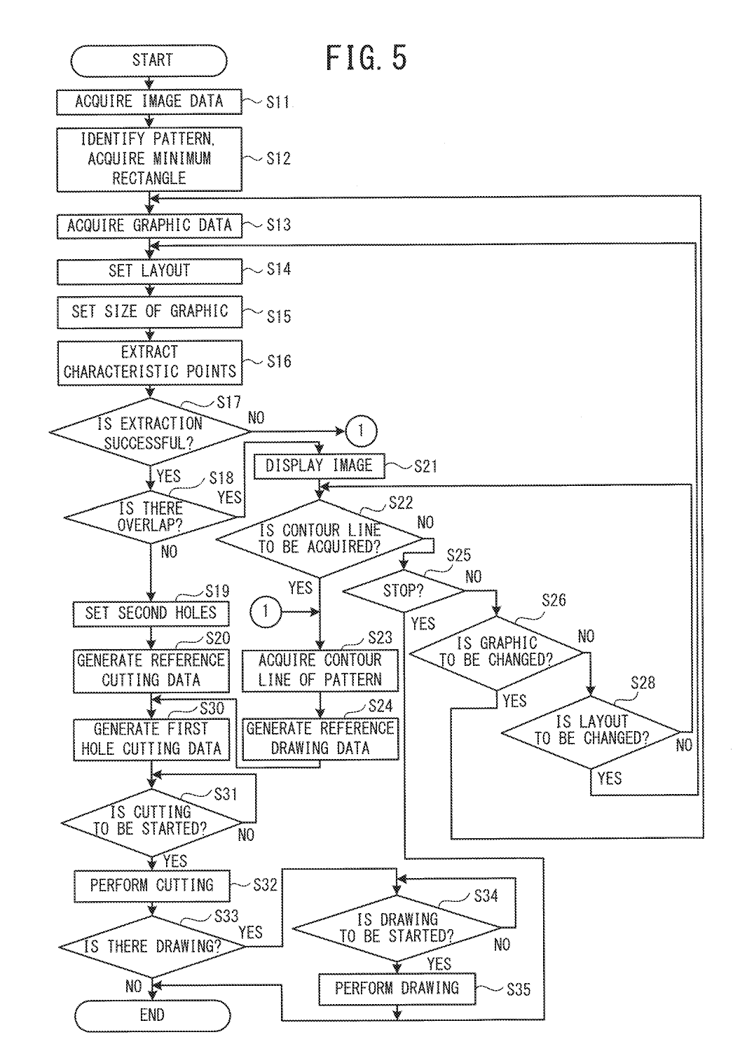

Main processing of the present embodiment will be explained with reference to FIG. 5 to FIG. 11. The main processing is processing performed separately from the data generation processing, and is processing in which generating conditions of the processing data used in the data generation processing are prescribed in more detail than in the data generation processing. When the workpiece 20 is processed using the data generating device 1, the main processing is processing that generates data capable of simplifying the operation to arrange the plurality of decorative components in combination with the pattern and carries out the process on the workpiece 20 in accordance with the generated data. When the control circuit 71 receives the start command, the control circuit 71 performs the main processing shown in FIG. 5 on the basis of the programs stored in the ROM 72. In the present embodiment, the control circuit 71 determines that the start command has been received when the start command is input by the panel operation. The start command includes the information specifying the graphic selected by the user.

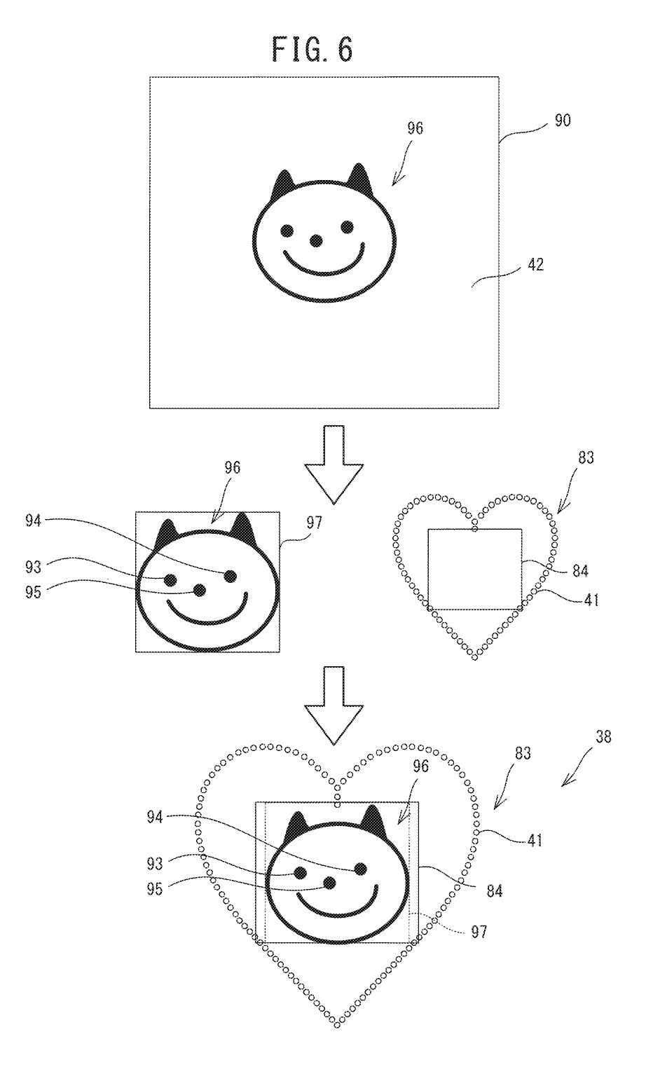

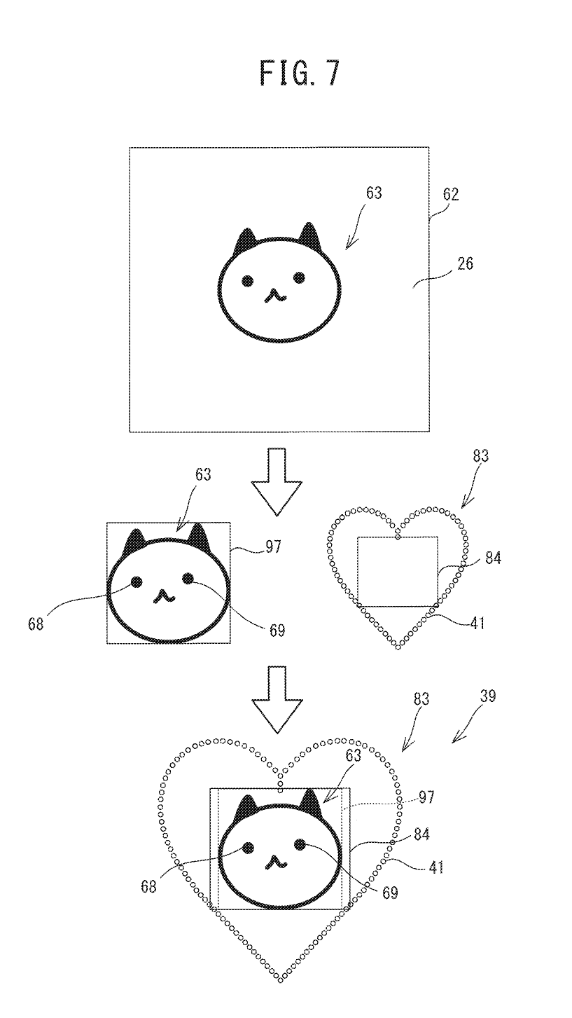

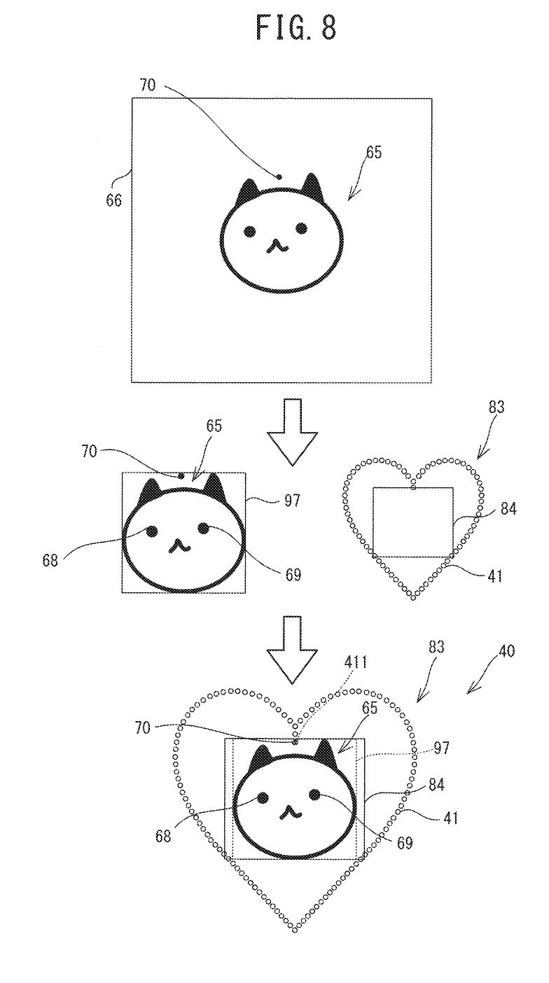

By the panel operation, the user selects the graphic, the size and shape of the first holes representing the graphic, and an interval between the plurality of first holes, and sets the retaining sheet 10 holding the sheet-like target object on the data generating device 1. After that, the user inputs the start command. The target object is, for example, paper, a cloth, or the like. A pattern, which is a target of the setting of the layout relationship, is arranged on the top surface of the target object. The pattern is, for example, a pattern printed on the paper, or an embroidery pattern sewn on a work cloth or the like. As a specific example 1, a case will be explained in which the control circuit 71 sets the layout relationship for a pattern 96 and the graphic 83 shown in FIG. 6. As a specific example 2, a case will be explained in which the control circuit 71 sets the layout relationship for the pattern 63 and the graphic 83 shown in FIG. 7. As a specific example 3, a case will be explained in which the control circuit 71 sets the layout relationship for a pattern 65 and the graphic 83 shown in FIG. 8. Hereinafter, the specific examples 1 to 3 will be explained in parallel, but in each of the specific examples 1 to 3, the main processing is performed individually at different timings. The pattern 65 is a pattern obtained by adding a circular dot 70 to the pattern 63. In the pattern 96, the pattern 63, and the pattern 65, a minimum rectangle that will be described later is the same.

As shown in FIG. 5, in the main processing, first, the control circuit 71 acquires image data (step S11). The control circuit 71 of the present examples drives the scanner portion 6 and reads the top surface of the target object held by the retaining sheet 10. The control circuit 71 acquires the image data generated by the scanner portion 6. In the specific example 1, image data representing an image 90 shown in FIG. 6 is acquired, and in the specific example 2, image data representing the image 62 shown in FIG. 7 is acquired. In the specific example 3, image data representing an image 66 shown in FIG. 8 is acquired.

The control circuit 71 performs image processing on the image data acquired at step S11 and identifies the pattern included in the image, and acquires the minimum rectangle that encompasses the identified pattern (step S12). The minimum rectangle of the present examples is a rectangle that extends in the X direction and the Y direction of the XY coordinate system. The control circuit 71 of the present examples sets the layout relationship between the pattern and the graphic using the minimum rectangle. The layout relationship is information including a relative position of the pattern and the graphic and a relative size of the graphic with respect to the pattern. In the specific examples 1 to 3, a minimum rectangle 97 is acquired as the minimum rectangle that encompasses the identified pattern.

On the basis of the information specifying the graphic 83 included in the start command, the control circuit 71 acquires the graphic data D21 from the graphic data storage area 80 of the EEPROM 74 (step S13). The control circuit 71 of the present examples also acquires the layout data D22 associated with the graphic data D21. The control circuit 71 of the present examples sets the layout relationship between the pattern and the graphic using the reference rectangle represented by the layout data.

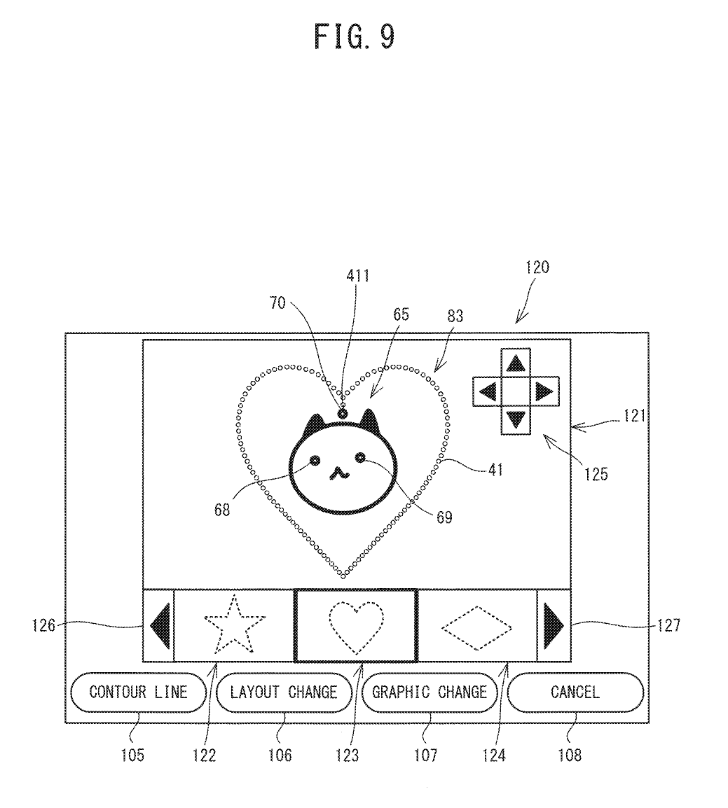

The control circuit 71 sets the layout relationship between the pattern and the graphic (step S14). The control circuit 71 of the present examples aligns a center of the minimum rectangle acquired at step S12 and a center of the reference rectangle represented by the layout data acquired at step S13, and sets the relative layout of the pattern and the graphic, as the layout relationship between the pattern and the graphic. Part or all of the layout relationship between the pattern and the graphic may be settable by the user using a screen that is similar to a screen 120 (refer to FIG. 9) that will be described later.

As the layout relationship between the pattern and the graphic, the control circuit 71 sets the size of the graphic represented by the graphic data D21 acquired at step S13 (step S15). Specifically, the control circuit 71 calculates, for each of the specific examples 1 to 3, an expansion/reduction ratio of the reference rectangle in accordance with the minimum rectangle 97 acquired at step S12. The expansion/reduction ratio is calculated in the following manner, for example. The control circuit 71 compares a value obtained by dividing the length in the X direction of the minimum rectangle by the length in the X direction of the reference rectangle with a value obtained by dividing the length in the Y direction of the minimum rectangle by the length in the Y direction of the reference rectangle, and uses the larger value as the expansion/reduction ratio of the graphic 83 represented by the graphic data D21. In other words, the expansion/reduction ratio in the X direction and the expansion/reduction ratio in the Y direction are the same. The control circuit 71 sets the size of the graphic 83 represented by the graphic data on the basis of the calculated expansion/reduction ratio. When the expansion/reduction ratio is not 1, the control circuit 71 changes a number of the hole shapes 41 as necessary, so that the plurality of hole shapes representing the graphic are arranged at the set interval. The expansion/reduction ratio in the X direction and the expansion/reduction ratio in the Y direction may be set to be different values. The user may be able to select whether the expansion/reduction ratio in the X direction and the expansion/reduction ratio in the Y direction are set as different values or are set as the same value. At least one of the expansion/reduction ratio in the X direction and the expansion/reduction ratio in the Y direction may be settable in accordance with a command from the user by the panel operation or the like.

In the specific example 1, by the processing at step S14 and step S15, a layout relationship 38 of the pattern 96 and the graphic 83 is set as shown in FIG. 6. The graphic 83 is expanded by the calculated expansion/reduction ratio. The reference rectangle 84 is expanded by the calculated expansion/reduction ratio. The number of hole shapes 41 representing the expanded graphic 83 is increased in accordance with the expansion of the original graphic 83. The center of the minimum rectangle 97 that encompasses the pattern 96 of the specific example 1 is aligned with the center of the expanded reference rectangle 84. Similarly, in the specific example 2, a layout relationship 39 of the pattern 63 and the graphic 83 is set as shown in FIG. 7, and in the specific example 3, a layout relationship 40 of the pattern 65 and the graphic 83 is set as shown in FIG. 8.

The control circuit 71 performs image processing on the image data acquired at step S11, and extracts characteristic points from the pattern represented by the image data (step S16). The processing to extract the characteristic points may be performed as necessary using a known method. For example, the characteristic points may be extracted using the following procedure. The control circuit 71 performs edge detection on the image data. A known method is used as the edge detection method, such as a method of applying a first-order derivative filter to the image and detecting a position at which a gradient is very large, a method of applying a second-order derivative filter to the image and detecting a zero crossing position, or the like. The control circuit 71 extracts points from the detected edge as the characteristic points. In the specific example 1 shown in FIG. 6, characteristic points 93 to 95 are extracted from the pattern 96 represented by the image data. In the specific example 2 shown in FIG. 7, characteristic points 68 and 69 are extracted from the pattern 63 represented by the image data. In the specific example 3 shown in FIG. 8, characteristic points 68 to 70 are extracted from the pattern 65 represented by the image data.

The control circuit 71 determines whether or not the extraction at step S16 has been successful (step S17). The control circuit 71 of the present examples determines that the extraction has been successful when at least three characteristic points have been extracted at step S16. In the specific examples 1 and 3, since the three characteristic points are extracted (yes at step S17), when the pattern and the graphic are arranged in accordance with the layout relationship set at step S14 and step S15, the control circuit 71 determines whether or not one or some of the at least three characteristic points extracted at step S16 overlaps with the plurality of hole shapes representing the graphic (step S18). For example, when the three characteristic points are extracted, if even one of the three characteristic points overlaps with the hole shape 41, it is determined that one or some of the at least three characteristic points extracted at step S16 overlaps with the plurality of hole shapes representing the graphic (yes at step S18).

In the specific example 1, as shown by the layout relationship 38 in FIG. 6, none of the characteristic points 93 to 95 overlaps with the hole shapes 41 representing the expanded graphic 83 (no at step S18). In this case, the control circuit 71 sets the size and the shape of the second hole (step S19). Taking the characteristic points extracted at step S16 as references, the second holes are holes formed in positions on the workpiece 20 corresponding to the references. The control circuit 71 of the present examples sets a minor axis of the second hole to be smaller than a minor axis of the first hole formed in accordance with the size and the shape of the hole shape 41. Further, the control circuit 71 of the present examples sets the second hole whose shape is different to the shape of the first hole. The control circuit 71 of the present examples sets the second hole from among the holes represented by the hole data stored in the hole data storage area 85. In the specific example 1, the square second hole is set such that a length L2 of the sides thereof is smaller than the diameter L1 of the circular first hole.

The control circuit 71 generates the processing data for performing the second processing (step S20). The second processing at step S20 is processing that causes the data generating device 1 to form the second hole in the position, on the workpiece 20, corresponding to the reference by cutting the workpiece 20. As the processing data for performing the second processing, the control circuit 71 generates cutting data for forming each of the second holes set at step S19, in the respective positions of the three characteristic points 93 to 95 extracted at step S16 in the specific example 1.

As shown in FIG. 7, in the specific example 2, the two characteristic points 68 and 69 are extracted (no at step S17) and thus the control circuit 71 acquires a contour line from the pattern represented by the image data acquired at step S11 (step S23). The control circuit 71 generates the processing data for performing the second processing (step S24). The processing data for performing the second processing at step S24 is data that causes the data generating device 1 to draw a drawing at the position, on the workpiece 20, corresponding to the reference. As the processing data for performing the second processing, the control circuit 71 takes the contour line acquired at step S23 as the reference and generates the drawing data that causes the data generating device 1 to draw the contour line, which is the reference, on the workpiece 20.

As shown in FIG. 8, in the specific example 3, of the three characteristic points 68 to 70, the characteristic point 70 overlaps a hole shape 411 among the plurality of hole shapes 41 representing the expanded graphic 83 (yes at step S18). In this case, on the basis of the layout relationship 40 set at step S14 and step S15, the control circuit 71 causes the layout of the plurality of hole shapes 41 with respect to the pattern 65, and the layout of the characteristic points 68 to 70 that are the references to be displayed on the LCD 51 (step S21). The control circuit 71 causes the screen 120 shown in FIG. 9 to be displayed on the LCD 51. As shown in FIG. 9, the screen 120 includes display fields 121 to 124, a layout change key group 125, graphic change keys 126 and 127, and input keys 105 to 108. The display field 121 is a field that displays the layout of the expanded graphic 83 designated by the plurality of hole shapes 41 with respect to the pattern 65, and the layout of the characteristic points 68 to 70, on the basis of the layout relationship 40 set at step S14 and step S15. The display fields 122 to 124 are fields that display the graphic represented by the graphic data stored in the graphic data storage area 80, which are read and displayed in accordance with commands from the graphic change keys 126 and 127. The display field 123 displays the selected graphic.

The layout change key group 125 includes keys that input commands to change the layout of the graphic 83 with respect to the pattern 65. The graphic change keys 126 and 127 are keys that input a command to change the selected graphic. The input key 105 is a key that inputs a command to use the contour line of the pattern as the reference. The input key 106 is a key that inputs a command to change the layout relationship between the pattern and the graphic in accordance with the commands from the layout change key group 125. The input key 107 is a key that inputs a command to change the selected graphic in accordance with the command from the graphic change keys 126 and 127. The input key 108 is a key that inputs a command to end the main processing without generating the processing data. The user refers to the screen 120 and verifies the layout of the expanded graphic 83 designated by the plurality of hole shapes 41 with respect to the pattern 65, and the layout of the characteristic points 68 to o70 that are the references, and inputs a command by the panel operation.

The control circuit 71 determines whether or not the command to use the contour line has been acquired (step S22). When the control circuit 71 detects that the input key 105 has been selected, the control circuit 71 determines that the command to use the contour line as the reference has been acquired. When the selection of the input key 105 is detected (yes at step S22), the control circuit 71 performs the above-described processing at step S23 and step S24.

When the selection of the input key 105 is not detected (no at step S22), the control circuit 71 determines whether or not selection of the input key 108 has been detected (step S25). When the input key 108 has been selected by the user in the specific example 3, the control circuit 71 detects the selection of the input key 108 (yes at step S25). In this case, the control circuit 71 ends the main processing without generating the processing data. When the selection of the input key 108 is not detected (no at step S25), the control circuit 71 determines whether or not selection of the input key 107 has been detected (step S26). When the selection of the input key 107 is detected (yes at step S26), the control circuit 71 acquires the graphic data of the selected graphic displayed in the display field 123 (step S13).

When the selection of the input key 107 is not detected (no at step S26), the control circuit 71 determines whether or not selection of the input key 106 has been detected (step S28). When the selection of the input key 106 is detected (yes at step S28), the control circuit 71 sets the layout relationship in accordance with layout information specified using the layout change key group 125 (step S14). When the selection of the input key 106 is not detected (no at step S28), the control circuit 71 returns the processing to step S22. The control circuit 71 may change the order of determining the detection of the selection of the input keys 105 to 108, namely, the order in which steps S22, S25, S26 and S28 are performed, as necessary.

After the processing at step S20 or step S24, the control circuit 71 generates the processing data for causing the data generating device 1 to perform the first processing (step S30). The processing data for causing the first processing to be performed is cutting data for causing the data generating device 1 to perform the processing to form the plurality of first holes representing the graphic in the positions indicated by the layout relationship set at step S14 and step S15 by cutting the workpiece 20. The graphic is the graphic obtained by changing the size of the graphic represented by the graphic data acquired at step S13 in accordance with the expansion/reduction ratio set at step S15. In the specific example 1, as shown in the lower section of FIG. 6, the cutting data is generated for causing the data generating device 1 to perform the processing to form the plurality of first holes representing the graphic 83 whose size has been changed, by cutting the workpiece 20 along each of the plurality of hole shapes 41 representing the graphic 83 whose size has been changed. In the specific example 2, as shown in the lower section of FIG. 7, the cutting data is generated for causing the data generating device 1 to perform the processing to form the plurality of first holes representing the graphic 83 whose size has been changed, by cutting the workpiece 20 along each of the plurality of hole shapes 41 representing the graphic 83 whose size has been changed.

The control circuit 71 determines whether or not the processing to cut the workpiece 20 in accordance with the generated processing data is to be started (step S31). The user sets the retaining sheet 10 holding the workpiece 20 on the data generating device 1, and mounts the cartridge 4 having the cutter in the cartridge holder 32. After that, the user inputs a cutting start command, by the panel operation. The control circuit 71 stands by until the cutting start command is acquired (no at step S31), and when the cutting start command is acquired (yes at step S31), the control circuit 71 performs the cutting processing in accordance with the cutting data (step S32). In the case of the specific example 1, the processing data for performing the cutting processing at step S32 includes the cutting data generated at step S20 and the cutting data generated at step S30. In the case of the specific example 2, the processing data for performing the cutting processing at step S32 is only the cutting data generated at step S30. The control circuit 71 drives the up-down drive mechanism 33 and moves the cartridge 4 to the lowered position. The control circuit 71 drives the movement mechanism 7 and the head movement mechanism 8 in accordance with the cutting data, and the workpiece 20 is cut in the shape specified by the cutting data by the retaining sheet 10 and the cartridge 4 being moved relative to each other in the Y direction and the X direction. In the specific example 1, both the first processing and the second processing are performed in the processing at step S32. In the specific example 2, only the first processing is performed in the processing at step S32.

The control circuit 71 determines whether or not the drawing data has been generated at step S24 (step S33). In the specific example 2, since the drawing data has been generated at step S24 (yes at step S33), the control circuit 71 determines whether or not a command to start the drawing has been acquired (step S34). In the state in which the retaining sheet 10 holding the workpiece 20 continues to be set on the data generating device 1, the user mounts the cartridge 4 having the pen in the cartridge holder 32, and after that, inputs a drawing start command by the panel operation. The control circuit 71 stands by until the drawing start command is acquired (no at step S34), and when the drawing start command is acquired (yes at step S34), the control circuit 71 performs the drawing processing in accordance with the drawing data generated at step S24 (step S35). The control circuit 71 drives the up-down drive mechanism 33 and moves the cartridge 4 to the lowered position. The control circuit 71 drives the movement mechanism 7 and the head movement mechanism 8 in accordance with the drawing data, and the shape specified by the drawing data is drawn on the workpiece 20 by the retaining sheet 10 and the cartridge 4 being moved relative to each other in the Y direction and the X direction. The second processing of the specific example 2 is performed at step S35. When the drawing data has not been generated at step 24 (no at step S33), as in the case of the specific example 1, or after the processing at step S35, the control circuit 71 ends the main processing. After the drawing processing from step S33 to step S35, the control circuit 71 may perform the cutting processing of step S31 and step S32.

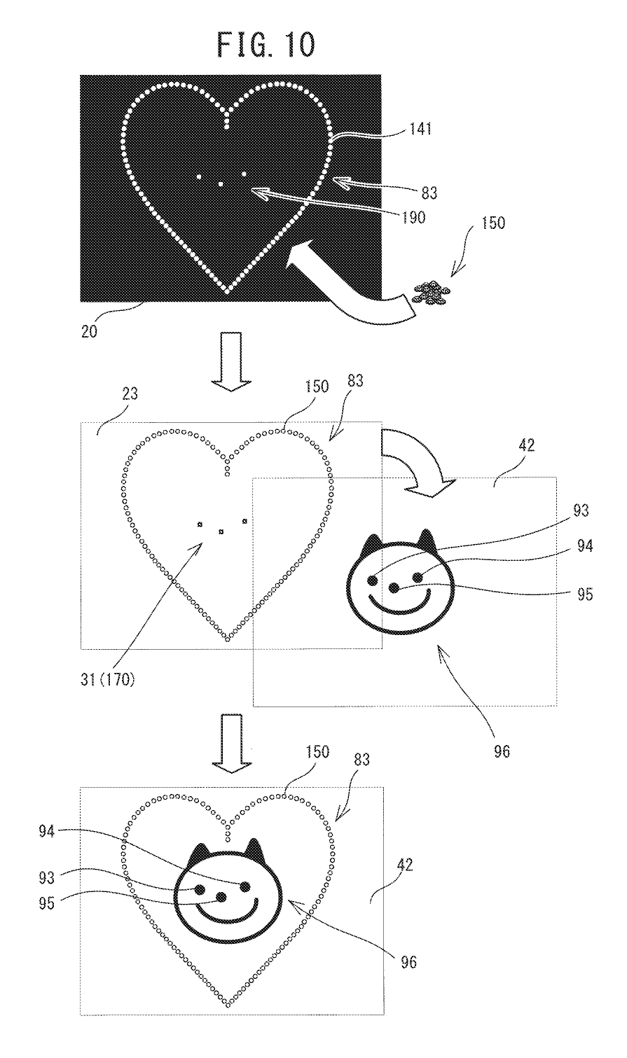

When the data generating device 1 has processed the workpiece 20 on the basis of the processing data generated in the specific example 1, the expanded graphic 83 designated by the plurality of first holes 141, and three second holes 190 representing a reference layout are formed in the workpiece 20, as shown in FIG. 10. The size, the shape and the layout with respect to the pattern of each of the plurality of first holes 141 match those of the plurality of hole shapes 41 representing the expanded graphic 83 shown in the lower section of FIG. 6. The user arranges the decorative components 150 in each of the plurality of first holes 141. The user adheres the decorative components 150 to the transfer sheet 23 and, after making marks 31 on the positions of the second holes 190, uses the marks 31 to perform position alignment with the pattern 96 on a target object 42. The user uses an iron or the like to fix the decorative components 150 to the target object 42, and the target object 42 is obtained on which the decorative components 150 and the pattern 96 are arranged in the layout relationship set at step S14 and step S15. The user may arrange decorative components 170, to the bottom surface of which the adhesive is not applied, in the second holes 190, adhere the decorative components 150 and the decorative components 170 to the transfer sheet 23, and use the decorative components 170 to perform the position alignment with the pattern 96 of the target object 42.

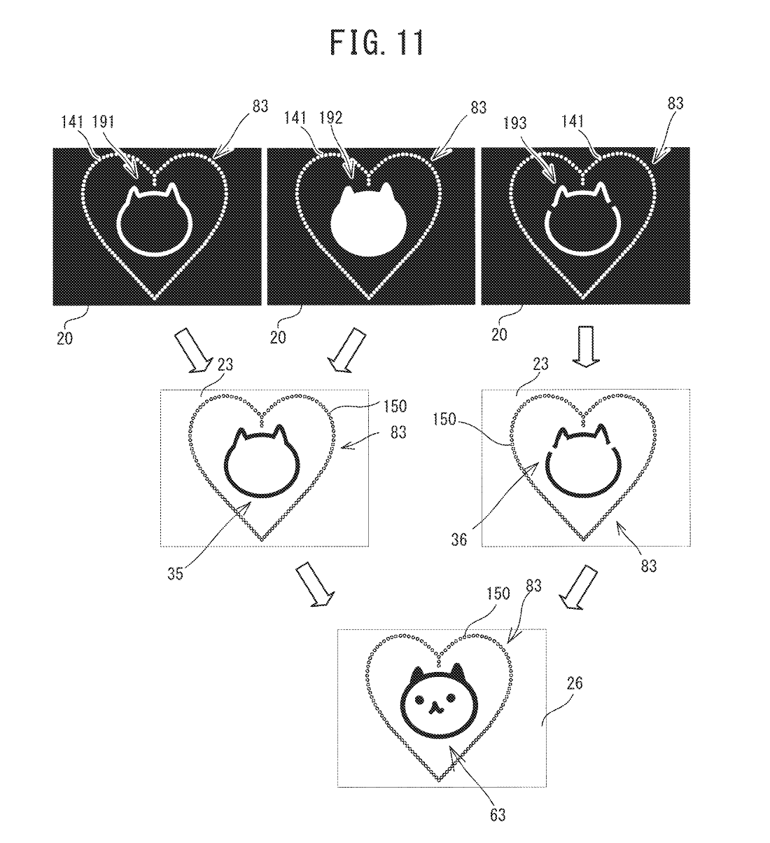

Similarly, when the data generating device 1 has processed the workpiece 20 on the basis of the processing data generated in the specific example 2, the expanded graphic 83 designated by the plurality of first holes 141 are formed in the workpiece 20, and a mark 191 representing the contour line that is the reference is drawn on the workpiece 20, as shown in FIG. 11. The user arranges the decorative components 150 in each of the plurality of first holes 141. The user adheres the decorative components 150 to the transfer sheet 23 and, after making a mark 35 by tracing the mark 191, uses the mark 35 to perform position alignment with the pattern 63 on the target object 26. The user uses an iron or the like to fix the decorative components 150 to the target object 26, and removes the transfer sheet 23. In this way, the target object 26 is obtained on which the decorative components 150 and the pattern 63 are arranged in the layout relationship set at step S14 and step S15.

The data generating device 1 of the above-described embodiment can set the layout of the graphic with respect to the pattern and can generate the processing data for performing the first processing that cuts the plurality of first holes representing the graphic, and for performing the second processing that carries out the process at the reference positions. The user can cause the data generating device 1 to form the plurality of first holes 141 in the workpiece 20 in accordance with the generated processing data (step S32). The user can use the data generating device 1 to carry out the process in the positions of the characteristic points or the characteristic graphic that are the references on the workpiece 20 (step S32, step S35). The user can arrange the decorative components 150 corresponding to the first holes 141 in the plurality of first holes 141 of the workpiece 20, for example. The user can easily and accurately arrange the plurality of decorative components so as to represent the graphic. By using the processing of the reference positions formed in or on the workpiece 20, the user can easily perform position alignment of the patterns 63, 65 or 96 with the graphic (the graphic 83) designated by the plurality of decorative components 150.

The control circuit 71 identifies the pattern represented by the image data from the image data acquired at step S11 (step S12). The control circuit 71 sets the layout and the size of the graphic with respect to the pattern, in accordance with the size of the identified pattern (step S14 and step S15). The data generating device 1 can automatically change the size of the graphic represented by the graphic data and the number of the hole shapes representing the graphic, in accordance with the size of the pattern. The user may set the layout and the size.

The second processing of the specific example 1 is the processing to form the second holes in the reference positions of the workpiece 20. More specifically, when the at least three characteristic points have been extracted from the pattern represented by the image data, and when none of the at least three characteristic points overlap with the plurality of hole shapes representing the graphic, the data generating device 1 sets the second processing to be the processing that forms the second holes in the reference positions of the workpiece 20. For this, the data generating device 1 can set the layout relationship between the graphic 83 with respect to the characteristic points 93 to 95 that are the references, and can generate the processing data for forming the plurality of first holes 141 representing the graphic 83 and the second holes 190 representing the reference positions. By using the second holes 190 formed in the workpiece 20, the user can easily perform the position alignment of the pattern 96 and the graphic 83 designated by the plurality of decorative components 150.

The second processing of the specific example 1 is the processing to form the second holes 190 that each has a smaller minor axis than the minor axis of each of the first holes 141. Thus, if the first holes 141 and the second holes 190 are respectively formed in the workpiece 20 on the basis of the processing data generated by the data generating device 1, the minor axis of each of the second holes 190 is smaller than the minor axis of each of the first holes 141, and thus the first holes 141 and the second holes 190 can be easily distinguished from each other. If the workpiece 20 is processed using the processing data generated by the data generating device 1, when the user arranges the decorative components 150 of the size corresponding to the first holes 141 in the plurality of first holes 141 in the workpiece 20, for example, it is possible to inhibit the decorative components 150 from being mistakenly arranged in the second holes 190.

The second processing of the specific example 1 is the processing to form the second holes 190 having a different shape to the shape of the first holes 141. Thus, if the first holes 141 and the second holes 190 are formed in the workpiece 20 on the basis of the processing data generated by the data generating device 1, the shape of the second holes 190 is different to the shape of the first holes 141, and thus the first holes 141 and the second holes 190 can be easily distinguished from each other. If the workpiece 20 is processed using the processing data generated by the data generating device 1, when the user arranges the decorative components of the shape corresponding to the first holes 141 in the plurality of first holes 141 in the workpiece 20, for example, it is possible to inhibit the decorative components from being mistakenly arranged in the second holes 190.

The data generating device 1 is provided with the drawing mechanism that can draw on the workpiece 20. The second processing of the specific example 2 is the processing that causes the data generating device 1 to draw in the position on the workpiece 20 corresponding to the mark 191 that is the reference. Thus, according to the data generating device 1, the reference position can be indicated by drawing. For example, by using the mark 191 drawn on the workpiece 20, the user can easily perform the position alignment of the pattern 63 and the graphic 83 designated by the plurality of decorative components 150.

The control circuit 71 extracts the at least three characteristic points from the pattern represented by the image data acquired at step S11, and acquires the extracted at least three characteristic points as the respective references. As in the specific example 1, if the workpiece 20 is processed on the basis of the processing data generated by the data generating device 1, in comparison to a case in which there are two or less characteristic points, the user can use the process formed on the workpiece 20 and can more accurately perform the position alignment of the pattern and the graphic designated by the plurality of decorative components.

As in the specific example 3, when one or some of the at least three characteristic points overlaps with the formation positions of the first holes, and when the user has specified the use of the contour line as the reference (yes at step S22), the data generating device 1 uses the contour line of the pattern as the reference. The data generating device 1 can generate the data that can avoid the overlapping of the first holes and the processing indicating the reference positions. For example, when the user performs the position alignment of the plurality of decorative components and the pattern, the user can more accurately perform the position alignment of the pattern 63 and the graphic 83 designated by the plurality of decorative components 150, on the basis of the mark 191.

As in the specific example 2, when it has not been possible to extract the at least three characteristic points from the pattern represented by the image data (no at step S17), the data generating device 1 can extract the contour line of the pattern and can acquire the extracted contour line as the reference (step S23). Even when the characteristic points cannot be extracted from the image data, the data generating device 1 can extract the contour line of the pattern as the reference. For example, when the user performs the position alignment of the plurality of decorative components and the pattern, the user can more accurately perform the position alignment of the pattern 63 and the graphic 83 designated by the plurality of decorative components 150, on the basis of the mark 191.

The control circuit 71 causes the layout of the plurality of first holes with respect to the pattern, and the layout of the references to be displayed on the LCD 51, on the basis of the layout relationship set at step S14 and step S15. According to the data generating device 1, using the LCD 51, the user can verify the layout of the plurality of first holes and the layout of the references, before the process, and before the processing data is generated, in particular. The control circuit 71 may cause the layout of the plurality of first holes with respect to the pattern and the layout of the references to be displayed on the LCD 51 after the generation of the processing data and before carrying out the process (between step S30 and step S31, for example). The user can ascertain, before the process, what kind of process will be performed on the workpiece 20 in accordance with the processing data generated by the data generating device 1.

The control circuit 71 receives a command to change the layout, which is displayed on the LCD 51, of the plurality of first holes with respect to the pattern. When the command is received, the control circuit 71 generates the processing data that causes the processing device to perform the second processing that carries out the process on the workpiece 20 in the reference positions, on the basis of the layout relationship between the pattern and the graphic designated by the plurality of first holes after the change is made in accordance with the command. The data generating device 1 of the present examples receives the change of the layout of the pattern and the selected graphic (step S28) and also receives the change of the selected graphic (step S26). According to the data generating device 1, the user can easily ascertain and change the hole shape of the plurality of first holes and the layout relationship with the references, which are displayed on the LCD 51. The user can ascertain, in advance, what kind of process will be carried out on the workpiece 20 in accordance with the data generated by the data generating device 1, and can change the layout when it is the unintended layout relationship. The data generating device 1 can improve the convenience for the user when performing the position alignment of the pattern and the graphic designated by the plurality of decorative components.

The data generating device and the data generation program of the present disclosure are not limited to the above-described embodiment, and various modifications may be added insofar as they do not depart from the scope and the spirit of the present disclosure. For example, the following modifications (A) and (B) may be added as appropriate.

(A) The data generating device 1 is not limited to being the processing device capable of performing the process that includes the cutting, and may be a personal computer (PC), a specialized device, a cloud server, or the like. It is sufficient that the processing data generated by the data generating device be usable by the processing device capable of carrying out the process, including the cutting, on the sheet-like workpiece 20. It is sufficient that the processing device be at least able to perform the cutting, and the processing device is not limited to the data generating device 1. The processing device need not necessarily be provided with the scanner portion and the drawing mechanism, and may be a processing device that is capable only of performing the cutting, or may be a processing device that can perform processing other than the cutting and the drawing. For example, the processing device may be a sewing machine that is provided with an imaging portion and on which a cutting needle can be mounted. A display portion provided on the data generating device may be a display device other than the LCD. The display portion may be omitted as appropriate. It is sufficient that the data generating device be capable of acquiring the image data that can identify the size of the pattern. The data generating device need not necessarily be provided with the scanner portion 6, and may acquire the image data from another device.

In the above-described embodiment, the explanation is given in which the data generation processing and the main processing are performed when the decorative components are arranged with respect to the pattern, but the present disclosure is not limited to this example. For example, applique or badges, such as studs (iron on studs) that can be adhered to a cloth or the like by heating using an iron or the like, lace (lace applique), a transfer sheet (an iron print sheet) or the like, may be used as the decorative components. The decorative components need not necessarily be adhered to the target object using an iron or the like, such as beads. The data generation processing and the main processing may be performed when creating a stencil template that is used for drawing a pattern represented by graphic data with respect to the pattern represented by the image data.

(B) Each step of the data generation processing and the main processing are not limited to the example performed by the control circuit 71, and some or all of the steps may be performed by another electronic device (an ASIC or the like). Each of the steps of the above-described processing may be performed through distributed processing by a plurality of electronic devices (a plurality of CPUs, for example). With respect to each of the steps of the data generation processing and the main processing of the above-described embodiment, the order can be changed, a step can be omitted or a step can be added, as necessary. A case in which an operating system (OS) or the like that operates on the data generating device 1 performs some or all of the actual processing on the basis of commands from the control circuit 71 of the data generating device 1, and the functions of the above-described embodiment are realized through that processing is also included in the scope of the present disclosure. For example, the following changes (B-1) to (B-7) may be added to the data generation processing and the main processing as appropriate.

(B-1) The reference acquired from the pattern represented by the image data may be changed as appropriate. The reference is changed in accordance with the number of the characteristic points extracted from the pattern, but the same reference (the contour line, for example) may be acquired irrespective of the number of the characteristic points. The data generating device 1 may be capable of setting the reference in accordance with a command input by the user. When one or more of the characteristic points are extracted from the pattern by the data generating device 1, all of the extracted characteristic points may be used as the references, or some of the extracted characteristic points may be used as the references. In this case, when using some of the extracted characteristic points as the references, it is preferable that the characteristic points that are separated from each other by a distance and the characteristic points that do not overlap with the hole shapes are selected as a priority. The data generating device 1 may acquire, as the reference, one or two characteristic points extracted from the pattern, and may generate the processing data to form the first holes representing the positions of the acquired characteristic points. In this case, at step S17 of the main processing shown in FIG. 5, the control circuit 71 may perform processing that determines the extraction to be successful when the number of characteristic points extracted from the pattern is one or more. In other words, at step S17, a threshold value used in the processing that determines that the extraction is successful may be changed as appropriate. The control circuit 71 may generate, as the processing data, the drawing data that represents the position of the at least one characteristic point.

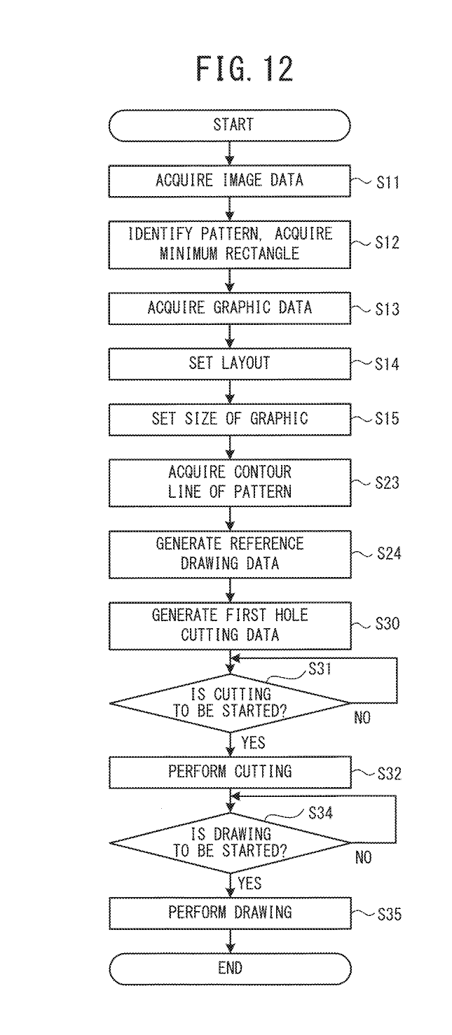

When the contour line of the pattern is the reference acquired from the pattern represented by the image data, the main processing may be changed as shown in FIG. 12, for example. In FIG. 12, the processing that is the same as the main processing shown in FIG. 5 is assigned the same reference numeral, and an explanation thereof is omitted. As shown in FIG. 12, in the main processing of a modified example, after performing the same processing as at step S11 to step S15 of the main processing in FIG. 5, the control circuit 71 extracts the contour line of the pattern (step S23), as the reference acquired from the pattern, and generates drawing data of the extracted contour line (step S24). The control circuit 71 performs the same processing as at step S30 to step S32, step S34 and step S35 in FIG. 5, and ends the main processing. In this case, when performing the position alignment of the plurality of decorative components and the pattern, the data generating device 1 uses the contour line of the pattern as the reference and, on the basis of the drawn contour line, can more accurately align the positions of the pattern and the graphic designated by the plurality of decorative components. At step S24 of the main processing shown in FIG. 12, cutting data may be generated to cut the workpiece along a part or all of the contour line used as the reference. The control circuit 71 may perform the cutting processing at step S31 and step S32 after the drawing processing at step S34 and step S35.

(B-2) The second processing may be processing that carries out a process that can be performed by the processing device at the positions on the workpiece 20 corresponding to the references, on the basis of the layout relationship. When the characteristic points extracted from the pattern are acquired as the references, the data generating device 1 may generate drawing data for drawing the hole shape, as the processing data for performing the second processing. The process indicating the references may be changed as appropriate in accordance with the process that can be performed by the processing device and in accordance with the type of the reference.

When the contour line of the pattern is acquired as the reference, the data generating device 1 may generate the cutting data for cutting the workpiece 20 along the contour line, as the processing data for performing the second processing. With respect to the above-described specific example 2, when the cutting data is generated for cutting the workpiece 20 along the contour line, the plurality of first holes 141 representing the heart-shaped graphic 83 whose size has been changed, and a mark 192 cut out along the contour line are formed in the workpiece 20, as shown in FIG. 11. The user arranges the decorative components 150 in each of the plurality of first holes 141. If the user adheres the decorative components 150 to the transfer sheet 23, and makes a mark 35 along the mark 192, the target object 26 in which the decorative components 150 and the pattern 63 are arranged in the layout relationship set at step S14 and step S15 is obtained by the procedure described above. When the contour line of the pattern is acquired as the reference, the data generating device may generate cutting data for cutting the workpiece 20 along a part of the contour line, as the processing data for performing the second processing. With respect to the above-described specific example 2, when the cutting data is generated for cutting the workpiece 20 along a part of the contour line, the plurality of first holes 141 representing the heart-shaped graphic 83 whose size has been changed, and a mark 193 cut out along a part of the contour line are formed in the workpiece 20, as shown in FIG. 11. The user arranges the decorative components 150 in each of the plurality of first holes 141. If the user adheres the decorative components 150 to the transfer sheet 23, and makes a mark 36 along the mark 193, the target object 26 in which the decorative components 150 and the pattern 63 are arranged in the layout relationship set at step S14 and step S15 is obtained by the procedure described above.

(B-3) It is sufficient that the graphic data be data representing the graphic. The graphic data may be, for example, data representing a graphic along the contour line that is generated by the data generating device extracting the contour line of the pattern represented by the image data. The graphic represented by the graphic data need not necessarily be the graphic designated by the plurality of hole shapes. In this case, in the processing at step S30, the processing data may be generated in order to represent the graphic represented by the graphic data using the plurality of first holes. The graphic data need not necessarily be associated with the layout data. In this case, the data generating device may generate the layout relationship between the pattern and the graphic by matching a representative point of the pattern and a representative point of the graphic, for example. The representative points of this case are, for example, the center point of the minimum rectangle or one of the four vertices of the minimum rectangle. The representative point of the pattern may be the same as the representative point of the graphic, or may be different. The reference rectangle represented by the layout data may be a shape other than a rectangle, such as a circular or elliptical shape, an octagonal shape or the like, and may be bigger than the graphic represented by the graphic data.

(B-4) At step S15, the processing to change the size of the graphic represented by the graphic data may be omitted as necessary. When the references acquired from the pattern and the hole shapes representing the graphic overlap, the processing data for forming the second holes representing the references in the workpiece 20 may be generated. When the settings are made such that the reference rectangle represented by the layout data does not overlap with the graphic represented by the graphic data, the processing at step S18 may be omitted. When the at least one characteristic point extracted from the pattern is acquired as the reference, the data generating device 1 may determine whether or not the acquired characteristic point overlaps with the hole shapes representing the graphic, and the data generating device 1 may receive the change of the layout relationship when the acquired characteristic point overlaps with the hole shapes representing the graphic.

(B-5) The processing to display, on the LCD 51, the layout of the plurality of first holes with respect to the pattern and the layout of the references, on the basis of the layout relationship set at step S14 and step S15, may be omitted as appropriate. The processing to display the layout of the plurality of first holes with respect to the pattern and the layout of the references on the LCD 51 may be performed at least between step S18 and step S19, or between step S23 and step S24. In this way, the user can ascertain, in advance, the layout of the plurality of first holes with respect to the pattern, and the layout of the references. In this case, the control circuit 71 may receive the change of the layout relationship between the pattern and the graphic set at step S14 and step S15. In this way, the user can adjust the layout of the plurality of first holes with respect to the pattern, and the layout of the references, as desired.

(B-6) The processing at step S26 and at step S28 may be omitted or changes as appropriate. For example, the data generating device 1 may receive a command to change at least one of the expansion/reduction ratio and an angle of the graphic with respect to the pattern, and a type of the first hole and an interval between the first holes, and may set the layout relationship between the pattern and the graphic in accordance with the acquired command. For example, when the data generating device 1 receives the command to change the angle of the graphic with respect to the pattern, an icon (not shown in the drawings) for changing the angle of the graphic may be provided on the screen 120, and the graphic may be rotated by a predetermined angle in the clockwise direction or the counterclockwise direction when the user performs the panel operation on the icon.

(B-7) The size and shape of the second holes with respect to those of the first holes may be changed as appropriate. At least one of the size and the shape of the first holes and the second holes may be the same.

The apparatus and methods described above with reference to the various embodiments are merely examples. It goes without saying that they are not confined to the depicted embodiments. While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. A data generating device comprising:
a processor; and
a memory configured to store computer-readable instructions that, when executed by the processor, instruct the processor to perform processes comprising:
acquiring image data representing a pattern;
acquiring graphic data representing a graphic;
setting a layout relationship between the pattern and the graphic;
acquiring, on the basis of the pattern represented by the acquired image data, a reference used in position alignment of the pattern and the graphic; and
generating, on the basis of the acquired graphic data, processing data that causes a processing device to perform first processing and second processing, the processing device being configured to carry out a process, including cutting, on a sheet-like workpiece, the first processing being processing to form a plurality of first holes designating the graphic by cutting the workpiece, and the second processing being processing to carry out a process at a position on the workpiece corresponding to the reference, on the basis of the layout relationship.

2. The data generating device according to claim 1, wherein the computer-readable instructions further instruct the processor to perform processes comprising:
identifying, from the acquired image data, the pattern represented by the image data; and
the setting includes setting a size and a layout of the graphic with respect to the pattern in accordance with a size of the identified pattern.

3. The data generating device according to claim 1, wherein
the processing data that causes the second processing to be performed is data causing the processing device to perform processing to form a second hole in the position on the workpiece corresponding to the reference by cutting the workpiece.

4. The data generating device according to claim 3, wherein
the processing data that causes the second processing to be performed is data causing the processing device to perform the processing to form the second hole having a smaller minor axis than a minor axis of the first hole.

5. The data generating device according to claim 3, wherein
the processing data that causes the second processing to be performed is data causing the processing device to perform the processing to form the second hole having a different shape to a shape of the first hole.

6. The data generating device according to claim 1, wherein
the processing data that causes the second processing to be performed is data causing the processing device provided with a processing mechanism capable of drawing on the workpiece to perform processing to draw at the position on the workpiece corresponding to the reference.

7. The data generating device according to claim 1, wherein
the acquiring the reference includes extracting at least one characteristic point from the pattern represented by the acquired image data, and acquiring each of the at least one extracted characteristic points as the reference.

8. The data generating device according to claim 7, wherein
when any of the at least one characteristic point extracted from the pattern represented by the image data overlaps with a formation position of the first hole, the acquiring the reference includes extracting a contour line of the pattern and acquiring the extracted contour line as the reference.

9. The data generating device according to claim 7, wherein
when the at least one characteristic point is not able to be extracted from the pattern represented by the image data, the acquiring the reference includes extracting a contour line of the pattern and acquiring the extracted contour line as the reference.

10. The data generating device according to claim 7, wherein
the at least one characteristic point is at least three of the characteristic points.

11. The data generating device according to claim 1, wherein
the acquiring the reference includes extracting a contour line from the pattern represented by the acquired image data, and acquiring the extracted contour line as the reference.

12. The data generating device according to claim 1, further comprising:
a display portion, and
wherein the computer-readable instructions further instruct the processor to perform a process comprising:
displaying on the display portion, on the basis of the set layout relationship, a layout of the plurality of first holes with respect to the pattern and a layout of the reference.

13. The data generating device according to claim 12, wherein
the computer-readable instructions further instruct the processor to perform a process comprising:
receiving a command to change the layout relationship displayed by the display portion, and
when the command is received, the generating includes generating the processing data that causes the processing device to perform the second processing which carries out the process at the reference position on the workpiece, on the basis of the layout relationship between the pattern and the graphic designated by the plurality of first holes after the change is made in accordance with the command.

14. A non-transitory computer-readable medium storing computer-readable instructions that, when executed, instruct a processor of a data generating device to perform processes comprising:
acquiring image data representing a pattern;
acquiring graphic data representing a graphic;
setting a layout relationship between the pattern and the graphic;
acquiring, on the basis of the pattern represented by the acquired image data, a reference used in position alignment of the pattern and the graphic; and
generating, on the basis of the acquired graphic data, processing data that causes a processing device to perform first processing and second processing, the processing device being configured to carry out a process, including cutting, on a sheet-like workpiece, the first processing being processing to form a plurality of first holes designating the graphic by cutting the workpiece, and the second processing being processing to carry out a process at a position on the workpiece corresponding to the reference, on the basis of the layout relationship.

15. The non-transitory computer-readable medium according to claim 14, wherein:
the processing data that causes the second processing to be performed is data causing the processing device to perform processing to form a second hole in the position on the workpiece corresponding to the reference by cutting the workpiece.

16. The non-transitory computer-readable medium according to claim 15, wherein:
the processing data that causes the second processing to be performed is data causing the processing device to perform the processing to form the second hole having a smaller minor axis than a minor axis of the first hole.

17. The non-transitory computer-readable medium according to claim 15, wherein:
the processing data that causes the second processing to be performed is data causing the processing device to perform the processing to form the second hole having a different shape to a shape of the first hole.

18. The non-transitory computer-readable medium according to claim 14, wherein:
the acquiring the reference includes extracting at least one characteristic point from the pattern represented by the acquired image data, and acquiring each of the at least one extracted characteristic points as the reference.

19. The non-transitory computer-readable medium according to claim 18, wherein:
when any of the at least one characteristic point extracted from the pattern represented by the image data overlaps with a formation position of the first hole, the acquiring the reference includes extracting a contour line of the pattern and acquiring the extracted contour line as the reference.

20. The non-transitory computer-readable medium according to claim 14, wherein:
the acquiring the reference includes extracting a contour line from the pattern represented by the acquired image data, and acquiring the extracted contour line as the reference.
